(19) United States
(12) Patent Application Publication
(10) Pub. No.: US 2013/0094131 A1
(43) Pub. Date: Apr. 18, 2013

(54) CASE FOR A TABLET COMPUTER

(71) Applicant: InMusic Brands, Inc., Cumberland, RI (US)

(72) Inventors: John E. O'Donnell, Ft. Lauderdale, FL (US); Paul C. Williamson, Providence, RI (US); Timothy S. Desplaines, Woonsocket, RI (US)

(73) Assignee: INMUSIC BRANDS, INC., Cumberland, RI (US)

(21) Appl. No.: 13/648,487

(22) Filed: Oct. 10, 2012

Related U.S. Application Data
(60) Provisional application No. 61/548,265, filed on Oct. 18, 2011.
(60) Provisional application No. 61/595,288, filed on Feb. 6, 2012.

(51) Int. Cl. G06F 1/16

(52) U.S. Cl. 361/679.02

(57) ABSTRACT

A case for a tablet computer is disclosed. The case includes an upper portion having a body portion configured and arranged to secure a tablet computer therein. The body portion has a rim defining an opening into the body portion to access a touch screen of the tablet computer. The case further includes a lower portion and a double hinge connecting the lower portion to the upper portion. A plurality of music controls is located on the lower portion that are configured and arranged to provide control inputs to the tablet computer.

### CROSS-REFERENCE TO RELATED APPLICATIONS

This patent document claims priority to earlier filed U.S. Provisional Patent Application Ser. No. 61/548,265, Oct. 18, 201, and U.S. Provisional Patent Application Ser. No. 61/565,286, filed on Nov. 30, 2011, the entire contents of which are incorporated herein by reference.

### BACKGROUND

1. Technical Field

The present patent document relates generally to protective case and peripherals for tablet computers and more particularly to a folding case for a tablet computer that includes a double-hinge feature, an optional kickstand, and has a custom control interface.

2. Background of the Related Art

Protective laptop-style cases for tablet computers are known in the art. However, these prior art cases suffer from a number of known limitations. Many of these cases do not provide an ability to prop the tablet computer up for easy viewing and manipulation of the tablet computer's touchscreen. Traditional, laptop-style cases do not have enough support to permit manipulation of the touch screen without deflecting the case further open, thus necessitating the use of two hands, one to support the case and the other to manipulate the touch screen.

Prior art cases also suffer from the limitation of not being able to lay fully open too. Because these prior art laptop-style cases cannot fully open to lay flat, the touchscreen winds up being angled away from the user, because the hinge is directly connected to the lower portion of the case. As a result, ergonomics are compromised and viewing angle for the user may become a problem.

Also these prior art cases may include keyboards, which are optimal for entering text, but do not have the preferred controls for specific applications.

Therefore, there is a perceived need in the industry for a protective laptop-style case for a tablet computer that provides added support to the touchscreen of the tablet computer and allows the tablet computer to lie fully flat, and also provides control interface optimized for other tasks than solely entering text.

### SUMMARY

The present invention solves the problems of the prior art by providing a case for a tablet computer that uniquely includes an upper portion and a lower portion connected via double hinge and an optional kickstand. The double hinge permits the case to lay flat or close flush together. The kickstand, if included, permits the case to be propped up partially open. Alternatively, the hinge may be figured to have enough friction to prevent the case from falling fully open.

The case also includes custom controls for specific applications, such as playing electronic drums, a piano keyboard, video game controls, audio mixing controls, DJ controller controls, and the like, which provide the user with a very intuitive user interface for specific applications.

### BRIEF DESCRIPTION OF THE DRAWINGS

These and other features, aspects, and advantages of the present invention will become better understood with reference to the following description, appended claims, and accompanying drawings where:

FIG. 1 is a perspective view of an embodiment of the case of the present invention partially open;

FIG. 2 is a perspective view of an embodiment of the case of the present invention closed;

FIG. 3 is a perspective view of an embodiment of the case of the present invention fully open in order to permit the case to lay flat;

FIG. 4 is a rear perspective view of an embodiment of the case of the present invention partially open;

FIG. 5 is a left side perspective view of an embodiment of the case of the present invention partially open;

FIG. 6 is a bottom view of an embodiment of the case of the present invention showing the case fully open;

FIG. 7 is a rear view of an embodiment of the case of the present invention showing the case closed;

FIG. 8 is a top view of an embodiment of the case of the present invention fully open;

FIG. 9 is a top view of an embodiment of the case of the present invention fully open having a piano keyboard configuration;

FIG. 10 is a top view of an embodiment of the case of the present invention fully open having an audio mixer configuration;

FIG. 11 is a top view of an embodiment of the case of the present invention fully open having a DJ controller configuration;

FIG. 12 is a top view of an embodiment of the case of the present invention fully open having an electronic drums configuration;

FIG. 13 is a top view of an embodiment of the case of the present invention fully open having a video game controller configuration;

FIG. 14 is a top, right perspective view of an alternative embodiment of the case of the present invention partially open;

FIG. 15 is a right side perspective view of an alternative embodiment of the case of the present invention partially open;

FIG. 16 is a rear view of an alternative embodiment of the case of the present invention partially open;

FIG. 17 is a top perspective view of an alternative embodiment of the case of the present invention partially open; and

FIG. 18 is a bottom view of an alternative embodiment of the case of the present invention partially open.

### DESCRIPTION OF THE PREFERRED EMBODIMENT

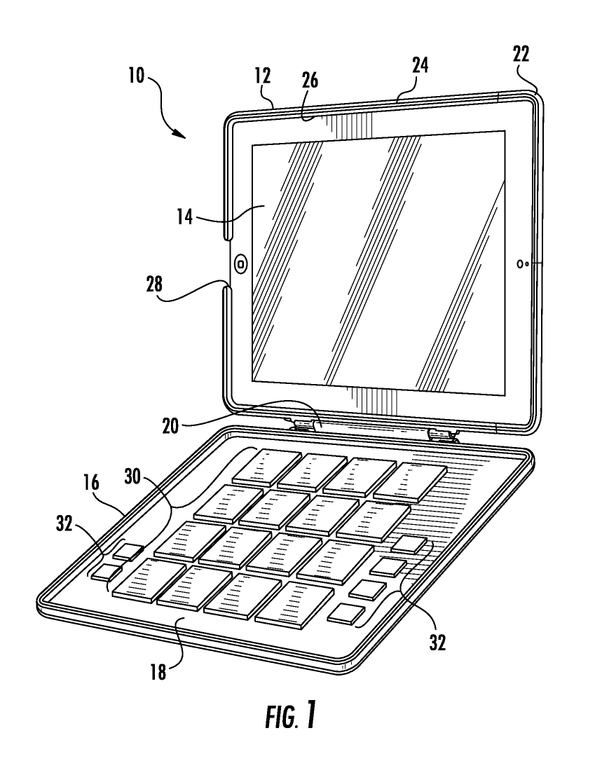

Referring now to FIGS. 1-3, a first embodiment of the case for a tablet computer is shown generally at 10 in three configurations, partially open, closed, and fully open. The case includes an upper portion 12 configured to hold a tablet computer 14 therein, a lower portion 16 having an interface peripheral 18 therein, and a double hinge 20 connecting the upper portion 12 to the lower portion 16.

The upper portion 12 and lower portion 16 of the case 10 preferably constructed from a rigid material to protect the tablet computer 14 from damage. The upper portion 12 includes a cap portion 22 and a body portion 24. The cap portion 22 is shown located on a right side of the body portion 24, but may also be located on a left side or a top of the body portion 24. The cap portion 22 is removable from the body portion 24. The body potion 24 is generally hollow and includes a rim 26 defining an opening to access a touch screen interface of the tablet computer 14. Removing the cap portion 22 permits a tablet computer 14 to be slid into the body portion 24. The rim 26 on the body portion 24 retains the tablet computer 14 inside the body portion 24, yet provides access to the touch screen of the tablet computer 14. The cap portion 22 is reattached to the body portion 24 to prevent the tablet computer 14 from sliding out of the body portion 24.

The upper portion 22 may include additional apertures, cutouts and relief structures 28 formed in the body portion 24 and/or cap portion 22 to permit access to connectors and buttons on the tablet computer 14.

The lower portion 24 preferably includes an interface peripheral 18, such as an alphanumeric keyboard or music instrument interface. As shown in the FIGS. 1-3, and 8, the preferred embodiment includes a simulated drum pad interface that includes sixteen, large drum pad buttons 30 arranged in a grid pattern and several function buttons 32 to enable a person to create music with tactile sensation lacking from tablet computer's 14 touch screen interface. The interface peripheral 18 may connect to the tablet computer 14 via a cable or wirelessly as is known in the art and need not be described herein.

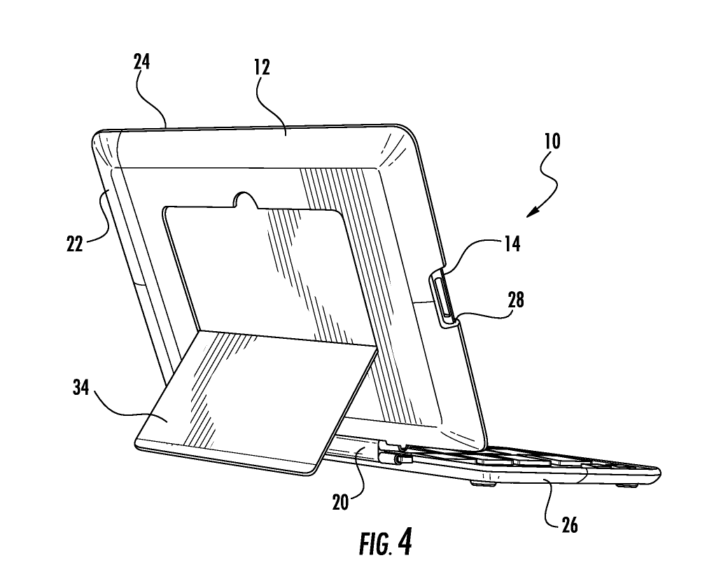

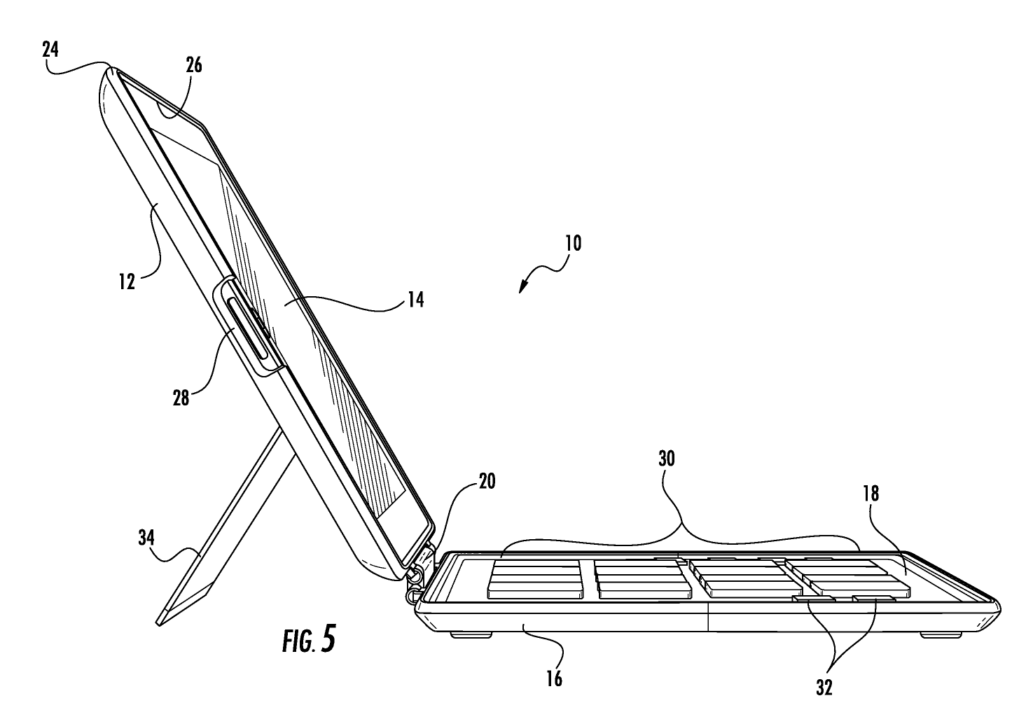

Referring to FIGS. 4 and 5, the upper portion 22 of the case 10 includes a movable kickstand 34. The kickstand 34 can be moved from a closed position, where it is stowed out of the way, and to an open position, where the kickstand 34 is deployed to prop up the upper portion 22 of the case 10 when partially open.

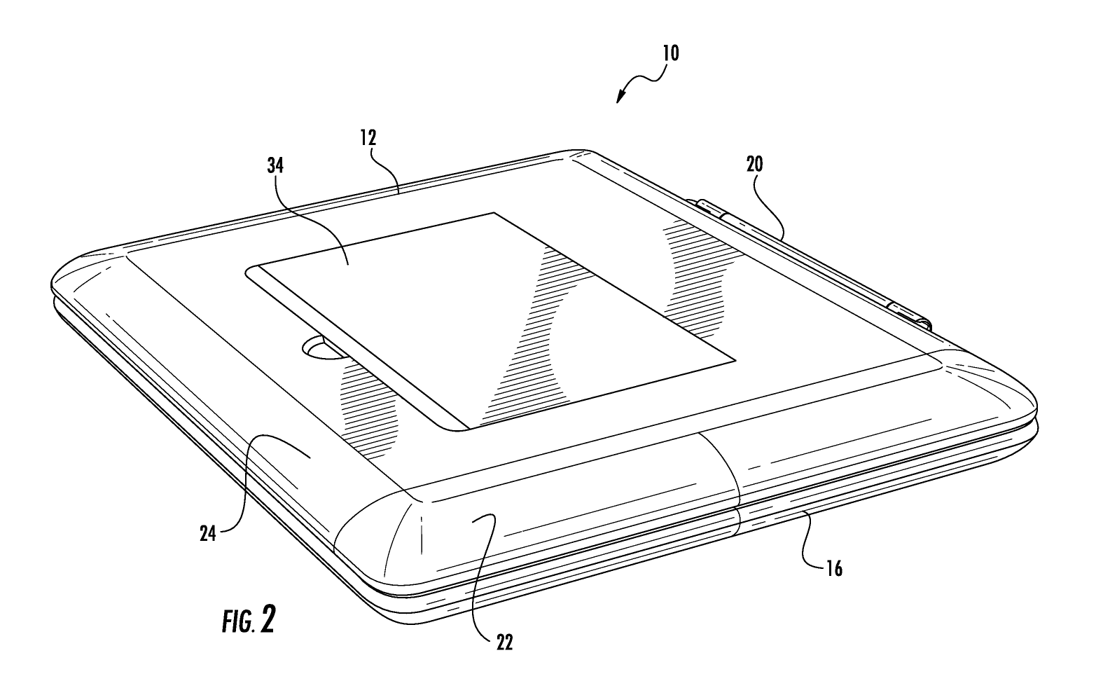

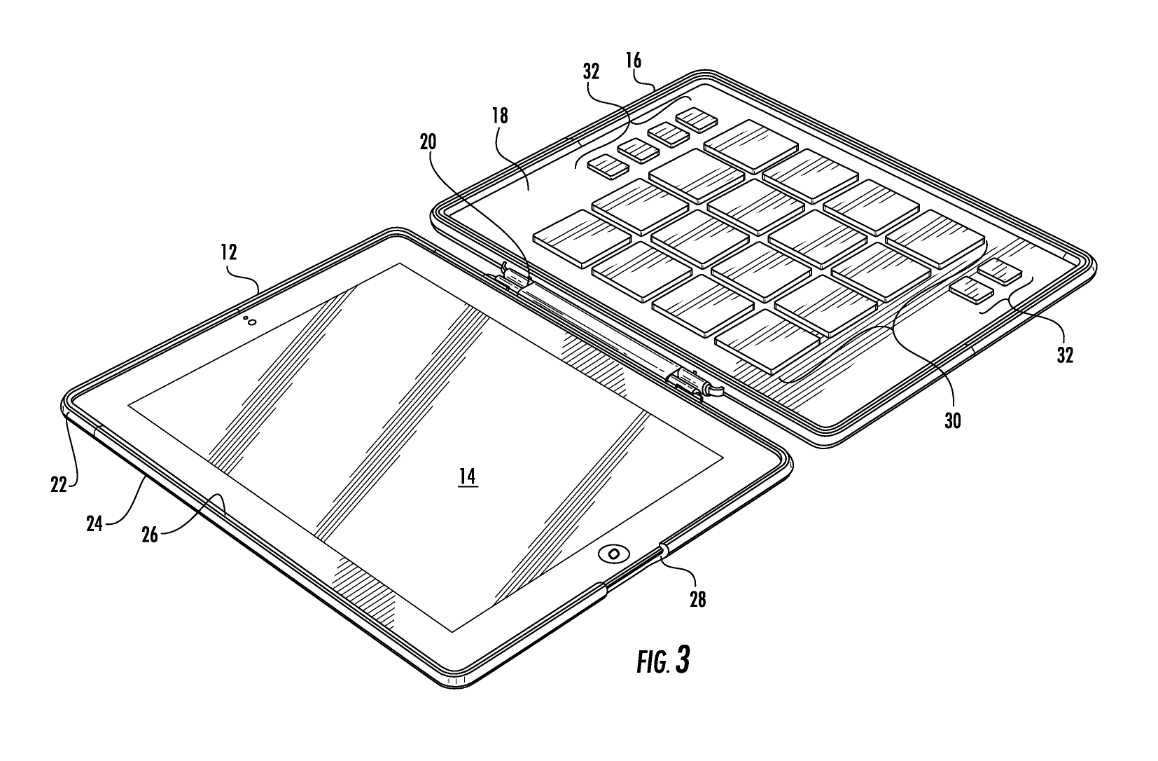

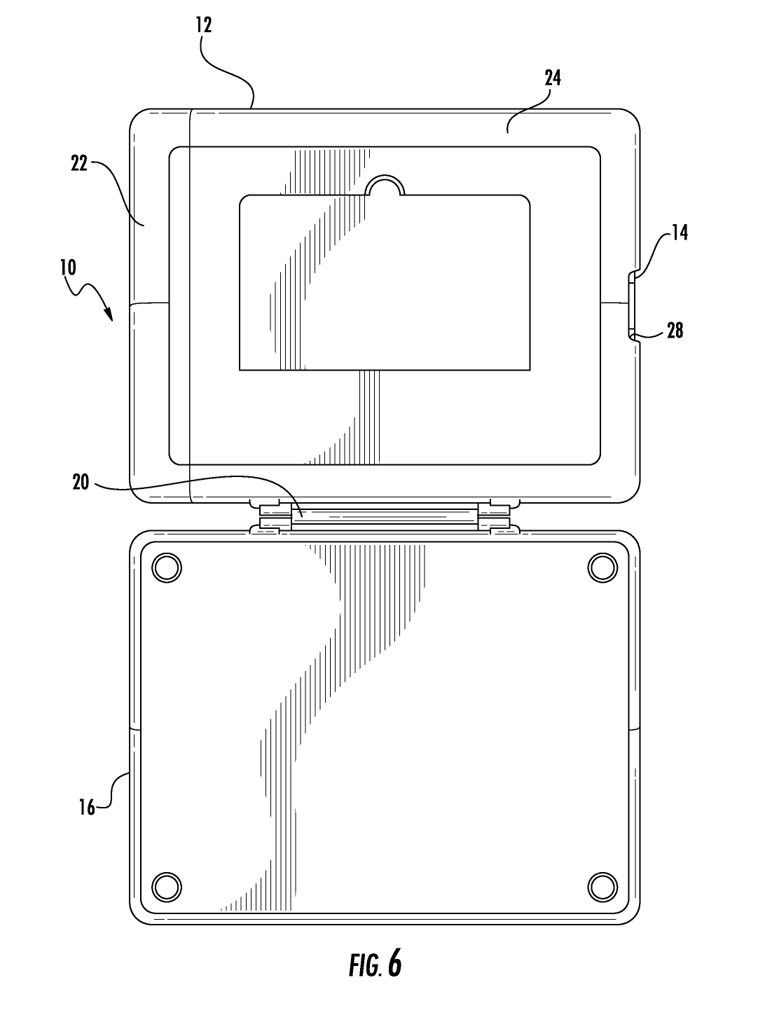

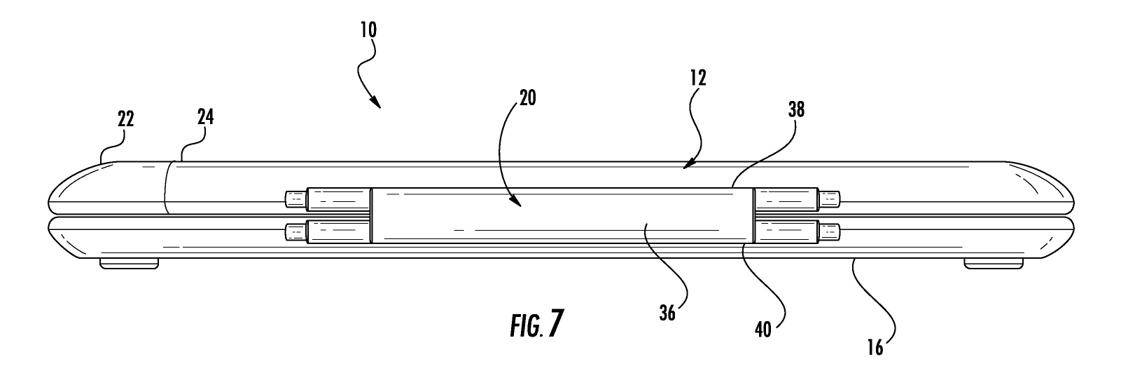

Referring to FIGS. 6 and 7, the upper portion 12 is connected to the lower portion 16 via a double hinge 20 that is pivotally connected to both the upper portion 12 and the lower portion 16. The double hinge 20 includes a strap portion 36 with a first end 38 hinged to the upper portion 12 and a second end 40 hinged to the lower portion 16. The strap portion 36 permits the upper portion 12 and the lower portion 16 to fold out and lay flat (best seen in FIGS. 3 and 6) or to mate flush together (best seen in FIGS. 2 and 7).

In the fully open position, the double hinge 20 may be locked open. In particular, the first end 38 and second end 40 of the strap portion 36 may include a locking mechanism, such as, detents that engage spring-biased locking pins on the upper portion 12 and lower portion 16, respectively, to selectively lock the case 10 in a fully open position. The detents and spring-biased locking pins may be reversed. Additional detents may be provided to provide multiple locking positions. Other locking mechanisms may be used.

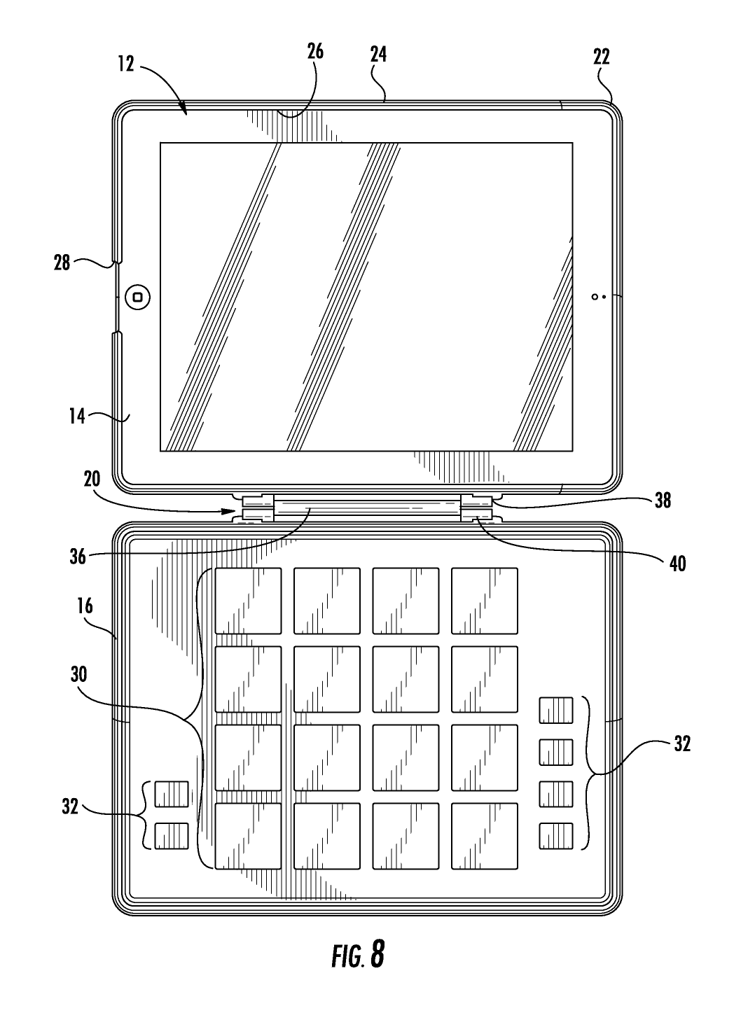

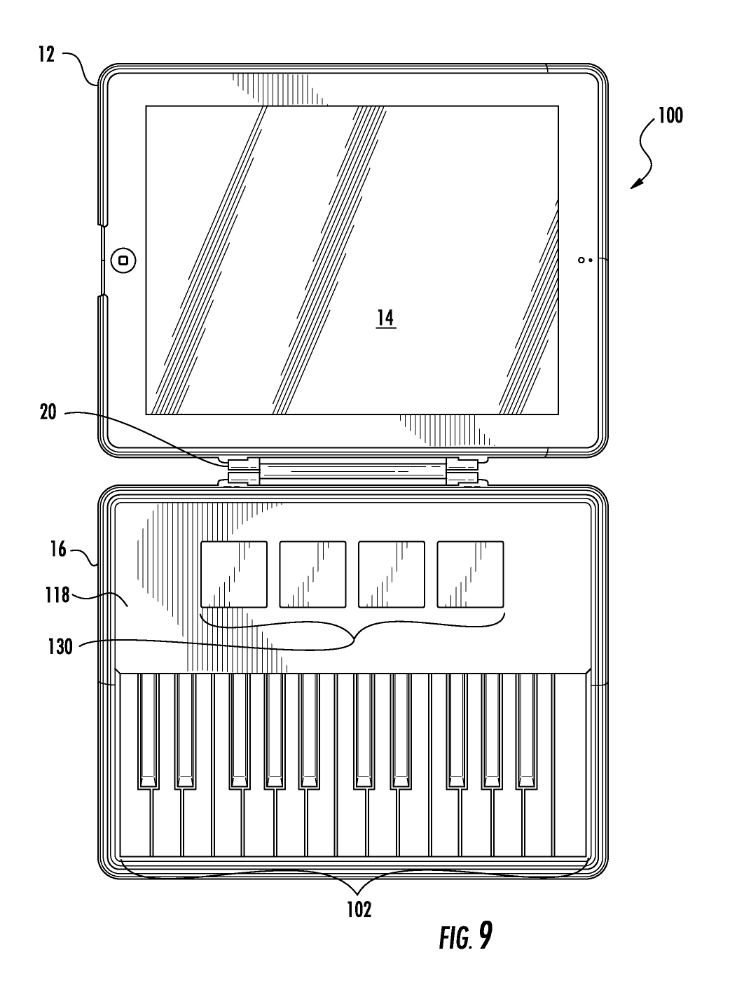

In addition to the large drum pads 30 shown in FIG. 8, the alternative interface peripherals may be used as shown in FIGS. 9-13.

Referring to FIG. 9, an alternative embodiment of the case is shown generally at 100. The interface peripheral 118 may be configured as a piano keyboard 102, which may optionally include a row of drum pads 130 as well.

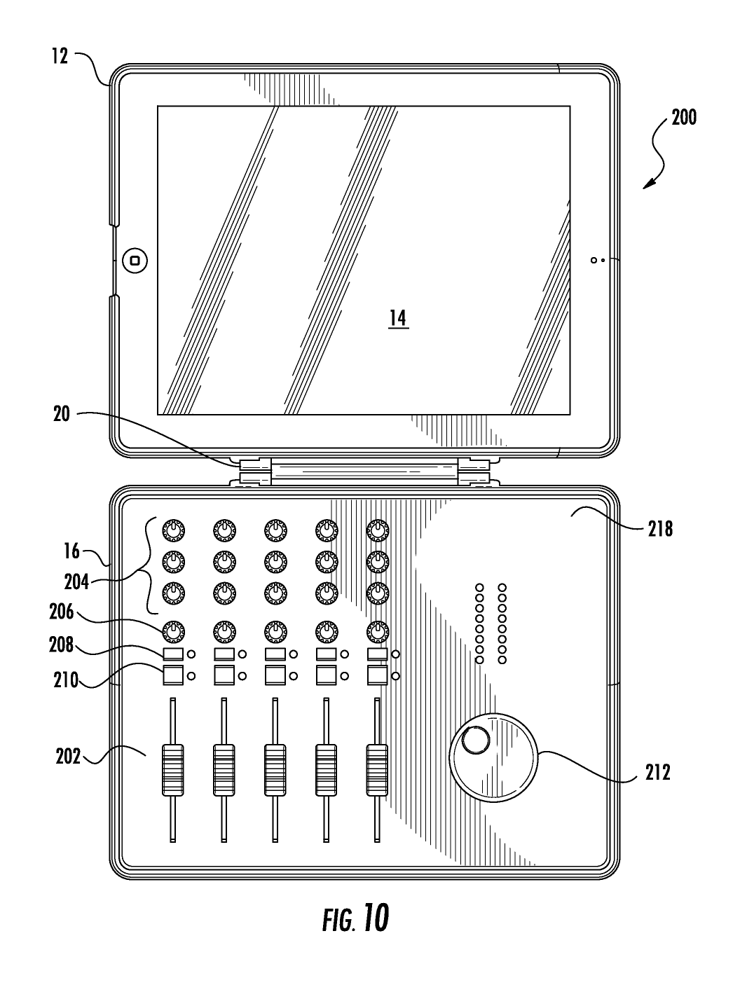

Referring to FIG. 10, an alternative embodiment of the case is shown generally at 200. The interface peripheral 218 may be configured as an audio mixer that includes controls for multiple channels of audio, such as volume sliders 202, equalizers 204, pan 206, solo 208, and mute controls 210. A select knob 212 may also be provided as well. Although five channels are shown, fewer or additional channels may be added.

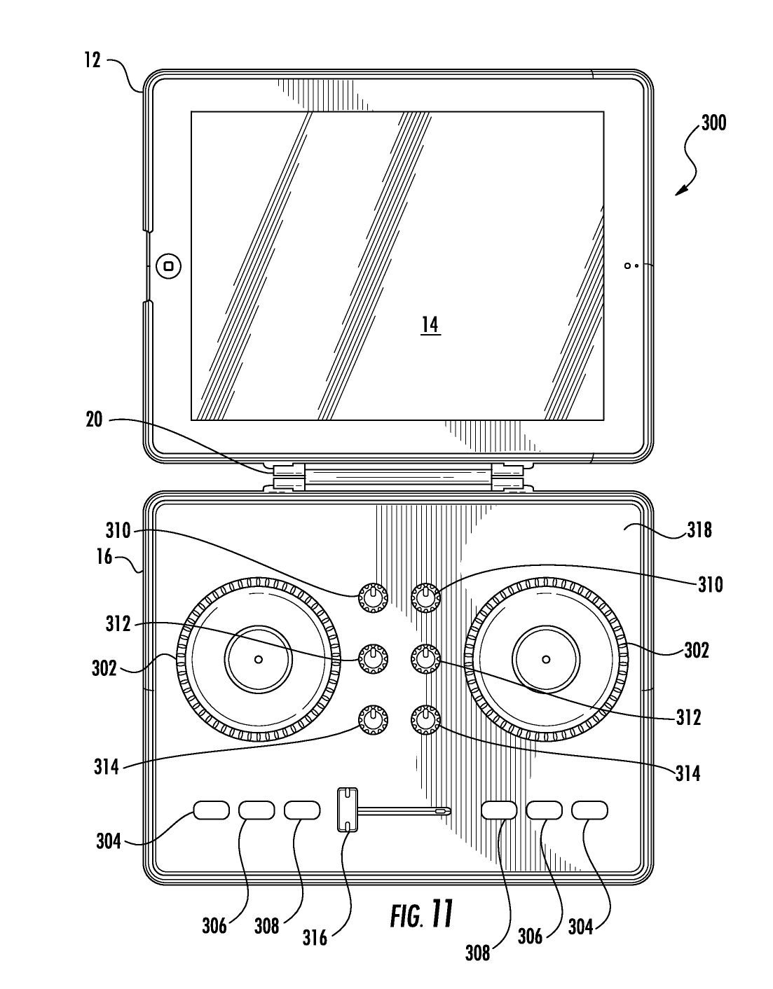

Referring to FIG. 11, an alternative embodiment of the case is shown generally at 300. The interface peripheral 318 may be configured as a DJ controller that includes dual simulated turntable controls 302 (or wheels), play/pause 304, loop 306, cue 308, volume 310, bass 312 and treble 314 controls for each audio source, and a cross-fader control 316 to cross-fade between audio sources.

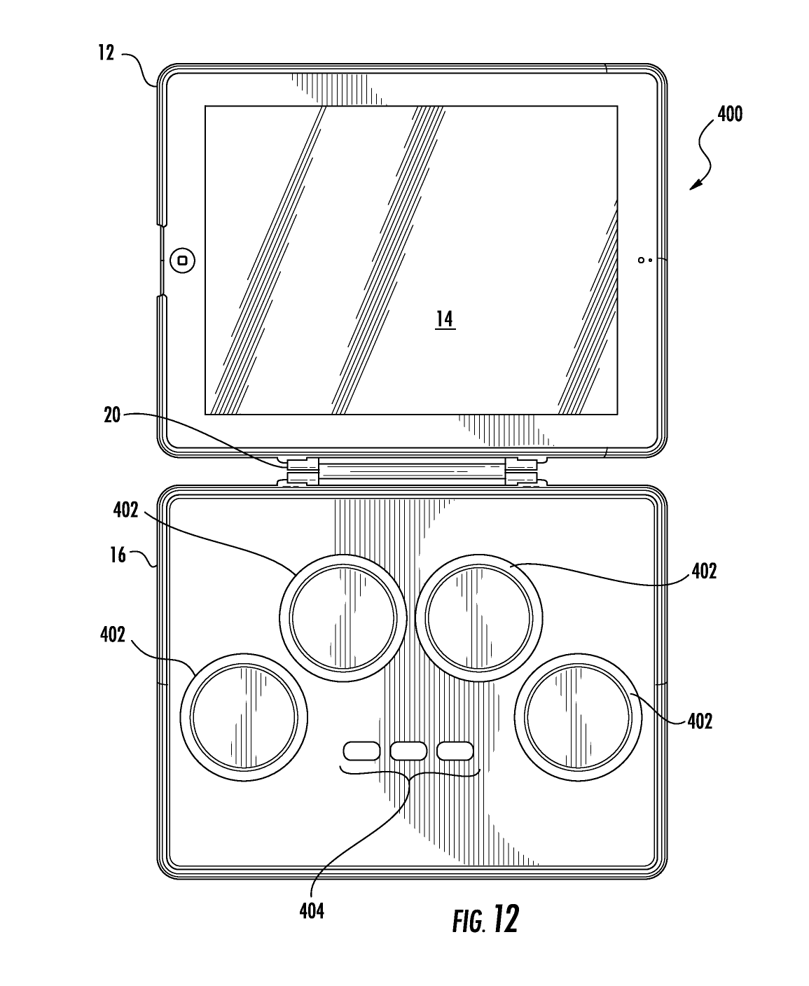

Referring to FIG. 12, an alternative embodiment of the case is shown generally at 400. The interface peripheral 418 may be configured as an electronic drum machine with four large drum pads 402, and optional function controls 404, arranged in a semi-circular arrangement found in acoustic drums.

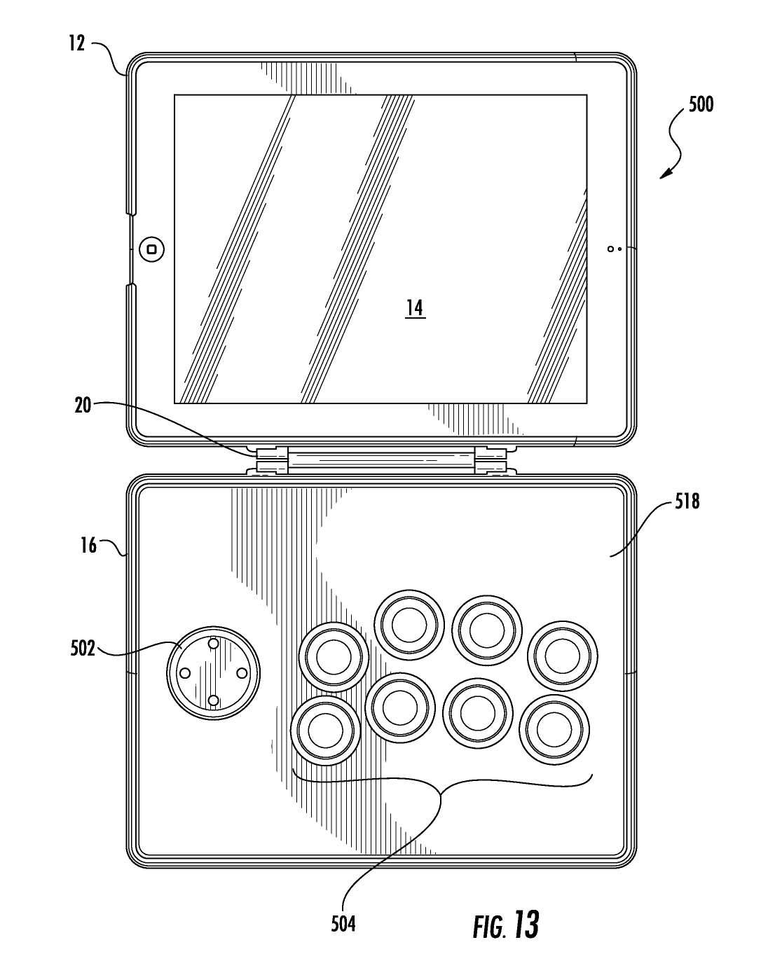

Referring to FIG. 13, an alternative embodiment of the case is shown generally at 500. The interface peripheral 518 may be configured with a D-pad 502 and a number of buttons 504 to provide a suitable interface for video game playing.

As can be seen in FIGS. 8-13, the interface peripheral may be configured to provide a customized and intuitive interface that compliments and enhances the user's ability to interact with a tablet computer 14.

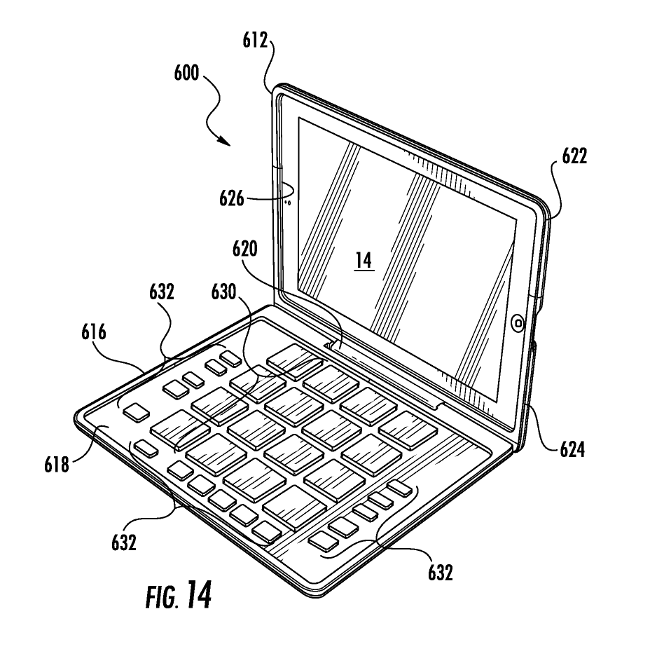

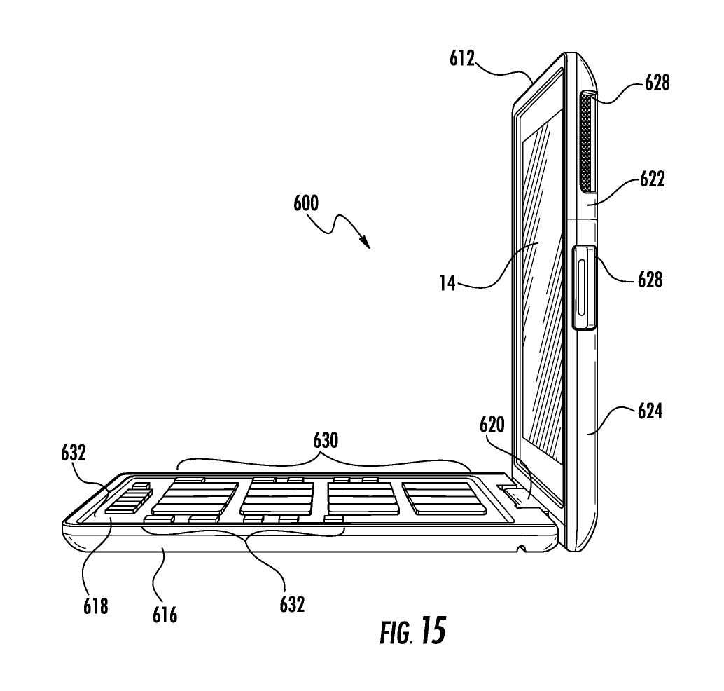

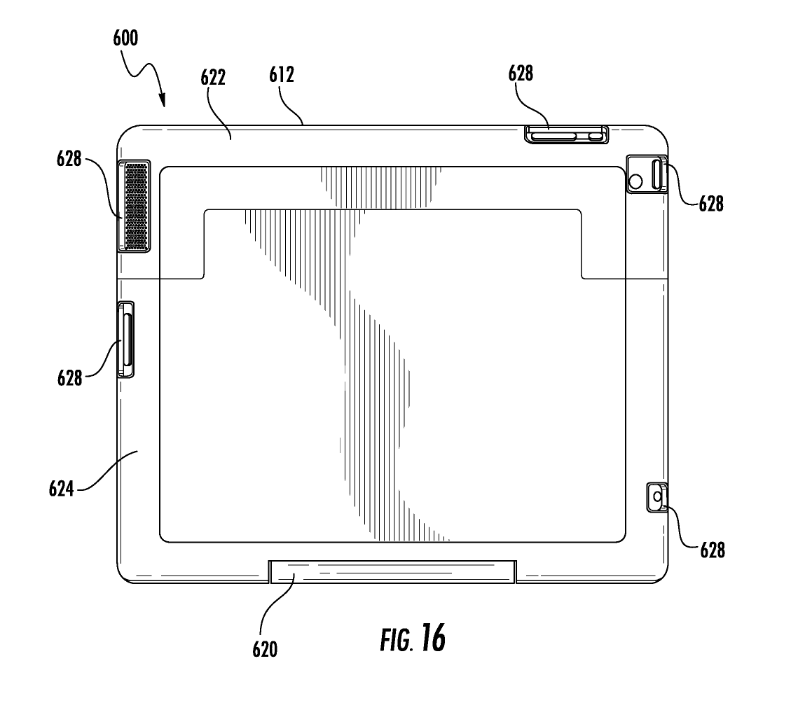

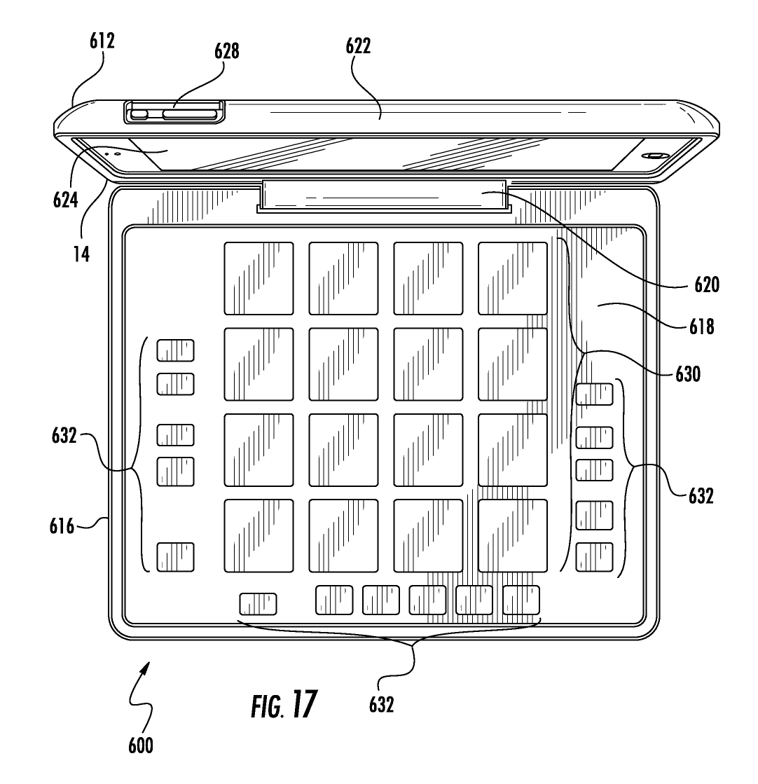

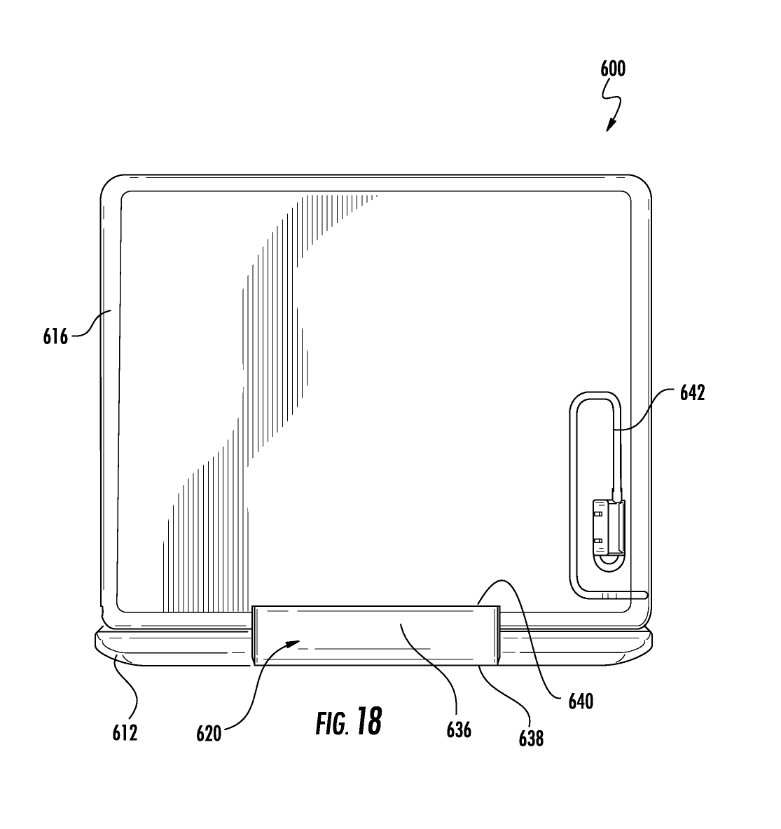

Referring now to FIGS. 14-18, an alternative embodiment of the case of the present invention is shown generally at 600. The case 600 includes an upper portion 612 configured to hold a tablet computer 14 therein, a lower portion 616 having an interface peripheral 618 therein, and a double hinge 620 connecting the upper portion 612 to the lower portion 616.

The upper portion 612 and lower portion 616 of the case 600 preferably constructed from a rigid material to protect the tablet computer 14 from damage. The upper portion 612 includes a cap portion 622 and a body portion 624. The cap portion 622 is shown located on a top of the body portion 624, but may also be located on a left side or a right side of the body portion 624. The cap portion 622 is removable from the body portion 624. The body potion 624 is generally hollow and includes a rim 626 defining an opening to access a touch screen interface of the tablet computer 14. Removing the cap portion 622 permits a tablet computer 14 to be slid into the body portion 624. The rim 626 on the body portion 624 retains the tablet computer 14 inside the body portion 626, yet provides access to the touch screen of the tablet computer 14. The cap portion 622 is reattached to the body portion 624 to prevent the tablet computer 14 from sliding out of the body portion 624.

The upper portion 624 may include additional apertures, cutouts and relief structures 628 formed in the body portion 624 and/or cap portion 622 to permit access to connectors and buttons on the tablet computer 14.

The lower portion 616 preferably includes an interface peripheral 618, such as simulated drum pads 630 as shown or any one of the interfaces 118, 218, 318, 418, 518 shown in the FIGS. 8-11. As shown, the alternative embodiment 600 includes a simulated drum pad interface that includes sixteen, large drum pad buttons 630 arranged in a grid pattern and several function buttons 632 to enable a person to create music with tactile sensation lacking from tablet computer's 14 touch screen interface. The number and position of the function buttons 623 may be varied. The interface peripheral 618 may connect to the tablet computer 14 via a cable 642 or wirelessly as is known in the art and need not be described herein.

The additional function controls may include, full level, first level, undo erase, note repeat, main, record, overdub, stop, play, play start, timing correct, track up, track down, mute track, and solo track controls as are known in the art.

The upper portion 612 is connected to the lower portion 616 via a double hinge 620 that is pivotally connected to both the upper portion 612 and the lower portion 616. The double hinge 620 includes a strap portion 636 with a first end 638 hinged to the upper portion 612 and a second end 640 hinged to the lower portion 616. The strap portion 636 permits the upper portion 612 and the lower portion 616 to fold out and lay flat or to mate flush together, like the first embodiment 10. The hinges includes sufficient friction and/or torque to hold the upper portion 612 in position relative to the lower portion 616 of the case.

In the fully open position, the double hinge 620 may be locked open. In particular, the first end 638 and second end 640 of the strap 636 may include a locking mechanism, such as, detents that engage spring-biased locking pins on the upper portion 612 and lower portion 616, respectively, to selectively lock the case 600 in a fully open position. The detents and spring-biased locking pins may be reversed. Additional detents may be provided to provide multiple locking positions. Other locking mechanisms may be used.

Therefore, it can be seen that the case for a tablet computer of the present invention provides a solution to the problem of providing a protective case for a tablet computer that includes multiple positions.

It would be appreciated by those skilled in the art that various changes and modifications can be made to the illustrated embodiments without departing from the spirit of the present invention. All such modifications and changes are intended to be within the scope of the present invention except insofar as limited by the appended claims.

What is claimed is:

1. A case for a tablet computer, comprising:
an upper portion having a body portion configured and arranged to secure a tablet computer therein, the body portion having a rim defining an opening into the body portion to access a touch screen of the tablet computer when placed therein;
a lower portion;
a double hinge connecting the lower portion to the upper portion; and
an interface peripheral on the lower portion configured and arranged to provide control inputs to the tablet computer.

2. The case of claim 1, wherein the interface peripheral includes drum pads.

3. The case of claim 2, wherein the drum pads are arranged in four by four grid.

4. The case of claim 2, wherein the drum pads are arranged in a semi-circular pattern.

5. The case of claim 2, wherein the interface peripheral includes a keyboard.

6. The case of claim 1, wherein the interface peripheral includes a keyboard.

7. The case of claim 6, wherein the interface peripheral further includes a row of four drum pads.

8. The case of claim 1, wherein the interface peripheral includes audio mixing controls.

9. The case of claim 8, wherein the audio mixing controls are selected from the group consisting essentially of volume sliders, equalizers, pan, solo, and mute controls.

10. The case of claim 8, wherein the interface peripheral includes a select knob.

11. The case of claim 1, wherein the interface peripheral includes a d-pad.

12. The case of claim 1, wherein the interface peripheral includes a simulated turntable.

13. The case of claim 1, wherein the interface peripheral includes a cross-fader control.

14. The case of claim 1, further comprising a cap portion removably connected to the body portion of the upper portion, the cap portion providing access to the interior of the body portion.

15. The case of claim 1, further comprising a kickstand movably connected to the upper portion.

16. The case of claim 1, further comprising a plurality of apertures, reliefs and cutouts on the upper portion configured and arranged to enable user access ports and buttons on the tablet computer when place in the upper portion.

17. The case of claim 1, wherein the double hinge is configured and arranged to allow the upper portion and lower portion to lie flat.

18. The case of claim 1, wherein the double hinge is configured and arranged to support the upper portion in an elevated position above the lower portion.

19. The case of claim 1, wherein the double hinge includes a strap portion with a first end hinged to the upper portion and a second end hinged to the lower portion.
